(19) United States
(12) Patent Application Publication
(10) Pub. No.: US 2019/0195080 A1
(43) Pub. Date: Jun. 27, 2019

(54) CERAMIC COATING SYSTEM AND METHOD

(71) Applicant: United Technologies Corporation, Farmington, CT (US)

(72) Inventors: Jose R. Paulino, Saco, ME (US); Christopher W. Strock, Kennebunk, ME (US)

(21) Appl. No.: 16/289,784

(22) Filed: Mar. 1, 2019

Related U.S. Application Data
(63) Continuation-in-part of application No. 14/812,668, filed on Jul. 29, 2015.
(60) Provisional application No. 62/033,883, filed on Aug. 6, 2014.

(51) Int. Cl. F01D 11/08; C23C 4/02

(52) U.S. Cl. CPC F01D 11/08; B33Y 10/00; C23C 4/02

(57) ABSTRACT

A gas turbine engine article includes a substrate that has at least one step, and the step includes an undercut. A thermally insulating topcoat is disposed on the substrate. The thermally insulating topcoat includes at least one fault that extends from the step.

### CROSS-REFERENCE TO RELATED APPLICATIONS

This disclosure is a continuation-in-part of U.S. application Ser. No. 14/812,668, filed Jul. 29, 2015, which claims priority to U.S. Provisional Application No. 62/033,883, filed on Aug. 6, 2014 and is incorporated herein by reference.

### BACKGROUND

A gas turbine engine typically includes a fan section, a compressor section, a combustor section, and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section.

Components that are exposed to high temperatures during operation of the gas turbine engine typically require protective coatings. For example, components such as turbine blades, turbine vanes, blade outer air seals (BOAS), and compressor components may require at least one layer of coating for protection from the high temperatures.

Some BOAS for a turbine section include an abradable ceramic coating that contacts tips of the turbine blades such that the blades abrade the coating upon operation of the gas turbine engine. The abradable material allows for a minimum clearance between the BOAS and the turbine blades to reduce gas flow around the tips of the turbine blades to increase the efficiency of the gas turbine engine. Over time, internal stresses can develop in the protective coating to make the coating vulnerable to erosion and spalling. The BOAS may then need to be replaced or refurbished after a period of use. Therefore, there is a need to increase the longevity of protective coatings in gas turbine engines.

### SUMMARY

A gas turbine engine article according to an example of the present disclosure includes a substrate that has at least one step. The at least one step has an undercut and a thermally insulating topcoat disposed on the substrate. The thermally insulating topcoat has at least one fault extending from the at least one step.

In a further embodiment of any of the foregoing embodiments, the at least one step includes, relative to an outer surface of the thermally insulating topcoat, a proximal surface, a distal surface, and a sidewall that joins the proximal surface and the distal surface, and the undercut is in the sidewall.

In a further embodiment of any of the foregoing embodiments, the sidewall defines a linear distance between the proximal surface and the distal surface, and the undercut defines a linear height of at least about 10% of the linear distance.

In a further embodiment of any of the foregoing embodiments, the sidewall defines a linear distance between the proximal surface and the distal surface, and the undercut defines a lateral undercut distance that is at least about 5% of the linear distance.

In a further embodiment of any of the foregoing embodiments, the at least one step includes, relative to an outer surface of the thermally insulating topcoat, a proximal surface, a distal surface, and a sidewall that joins the proximal surface and the distal surface, and the undercut is in the distal surface.

In a further embodiment of any of the foregoing embodiments, the sidewall defines a linear distance between the proximal surface and the distal surface, and the undercut has a linear height of less than about 50% of the linear distance.

In a further embodiment of any of the foregoing embodiments, the sidewall defines a diametric distance, and the undercut defines a lateral undercut distance that is less than about 50% of the diametric distance.

In a further embodiment of any of the foregoing embodiments, the at least one step includes, relative to an outer surface of the thermally insulating topcoat, a proximal surface, a distal surface, and a sidewall that joins the proximal surface and the distal surface, and the sidewall and the proximal surface meet at a 90° corner.

In a further embodiment of any of the foregoing embodiments, the at least one step is annular.

In a further embodiment of any of the foregoing embodiments, the at least one step includes a plurality of steps in a pattern.

In a further embodiment of any of the foregoing embodiments, the at least one fault is a microstructural discontinuity in the topcoat.

In a further embodiment of any of the foregoing embodiments, the fault extends to a surface of the thermally insulating topcoat.

A gas turbine engine according to an example of the present disclosure has a plurality of rotatable blades, and a seal arranged radially outwards of the plurality of rotatable blades. The seal has a substrate that has at least one step. The at least one step has an undercut, and a thermally insulating topcoat disposed on the substrate. The thermally insulating topcoat has at least one fault extending from the at least one step.

In a further embodiment of any of the foregoing embodiments, the at least one step includes, relative to an outer surface of the thermally insulating topcoat, a proximal surface, a distal surface, and a sidewall that joins the proximal surface and the distal surface, and the undercut is in the sidewall.

In a further embodiment of any of the foregoing embodiments, the at least one step includes, relative to an outer surface of the thermally insulating topcoat, a proximal surface, a distal surface, and a sidewall that joins the proximal surface and the distal surface, and the undercut is in the distal surface.

In a further embodiment of any of the foregoing embodiments, the at least one step is annular.

A method for fabricating a gas turbine engine article according to an example of the present disclosure includes forming at least one step in a substrate. The at least one step has an undercut, which deposits a thermally insulating topcoat on the substrate. The thermally insulating topcoat forms at least one fault during the depositing that extends from the at least one step.

In a further embodiment of any of the foregoing embodiments, the forming includes forming the at least one step and undercut using at least one of additive manufacturing, chemical milling, or mechanical milling.

In a further embodiment of any of the foregoing embodiments, the at least one step includes, relative to an outer surface of the thermally insulating topcoat, a proximal surface, a distal surface, and a sidewall that joins the proximal surface and the distal surface, and the undercut is formed in the sidewall.

In a further embodiment of any of the foregoing embodiments, the at least one step includes, relative to an outer surface of the thermally insulating topcoat, a proximal surface, a distal surface, and a sidewall that joins the proximal surface and the distal surface, and the undercut is formed in the distal surface.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates an example gas turbine engine.

FIG. 2 illustrates a turbine section of the gas turbine engine of FIG. 1.

FIG. 3 illustrates an example portion of a turbine component.

FIG. 4 illustrates a perspective view of another example turbine component.

FIG. 5 illustrates another perspective view of the turbine component of FIG. 4.

FIG. 6 illustrates an example portion of the turbine component of FIG. 4.

FIG. 7A illustrates a cross-section of a representative portion of another example gas turbine engine article.

FIG. 7B illustrates a radial outward view of the gas turbine engine article of FIG. 7A.

FIG. 8A illustrates a cross-section of a representative portion of another example gas turbine engine article.

FIG. 8B illustrates a radial outward view of the gas turbine engine article of FIG. 8A.

FIG. 9 illustrates a comparative example of a deposition process using a substrate that has a step without an undercut.

FIG. 10 illustrates a comparative example of a deposition process using a substrate that has a step with an undercut.

FIG. 11 illustrates an example method for fabricating a gas turbine engine article.

### DETAILED DESCRIPTION

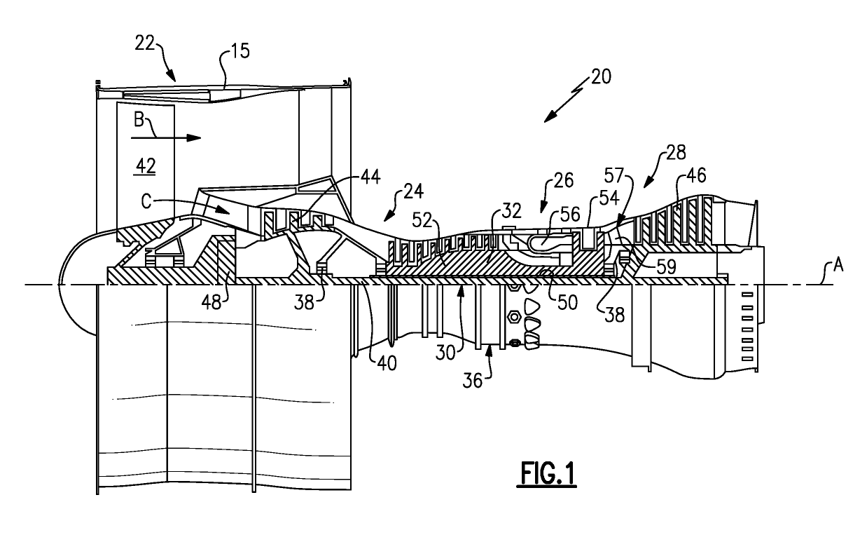

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

FIG. 2 illustrates a portion of the turbine section 28 of the gas turbine engine 20. Turbine blades 60 receive a hot gas flow from the combustor section 26 (FIG. 1). A blade outer air seal (BOAS) system 62 is located radially outward from the turbine blades 60. The BOAS system 62 includes multiple seal members 64 circumferentially spaced around the axis A of the gas turbine engine 20. Each seal member 64 is attached to a case 66 surrounding the turbine section by a support 68. It is to be understood that the seal member 64 is only one example of an article within the gas turbine engine that may benefit from the examples disclosed herein.

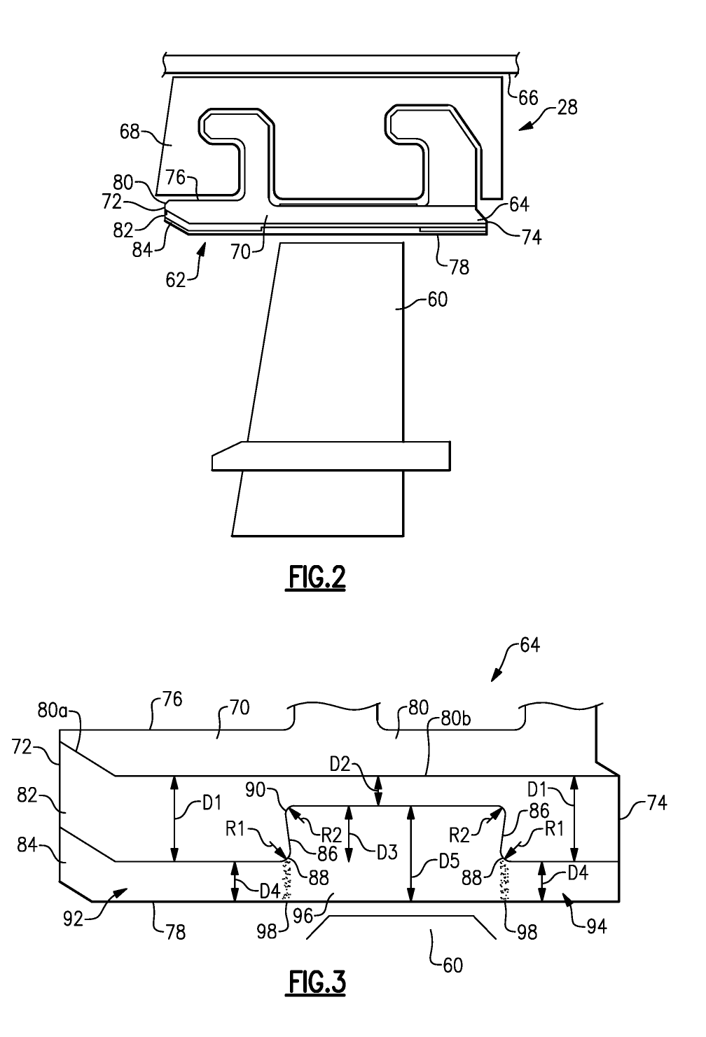

FIG. 3 illustrates a portion of the seal member 64 having two circumferential sides 70 (one shown), a leading edge 72, a trailing edge 74, a radially outer side 76, and a radially inner side 78 that is adjacent the hot gas flow and the turbine blade 60. The term “radially” as used in this disclosure relates to the orientation of a particular side with reference to the axis A of the gas turbine engine 20.

The seal member 64 includes a substrate 80, a bond coat 82 covering a radially inner side of the substrate 80, and a thermally insulating topcoat 84 covering a radially inner side of the bond coat 82. In this example, the bond coat 82 covers the entire radially inner side of the substrate 80 and the thermally insulating topcoat 84 is a thermal barrier made of a ceramic material. The substrate 80 includes a slanted region 80a adjacent the leading edge 72 and a downstream portion 80b having a generally constant radial dimension.

The bond coat 82 includes a thicker region D1 adjacent the leading edge 72 and the trailing edge 74 and a thinner region D2 axially between the thicker regions D1. The thinner region D2 extends axially from upstream of the turbine blade 60 to downstream of the turbine blade 60.

A step 86 is formed in the bond coat 82 between both of the thicker regions D1 and the thinner region D2. The step 86 extends in a radial and circumferential direction such that multiple BOAS systems 62 arranged together form a circumference around the axis A of the gas turbine engine 20 with the step 86 extending entirely around the circumference.

The step 86 includes a radially inner edge 88 having a radius R1 and a radially outer fillet 90 having a radius R2. In one example, the step 86 extends generally perpendicular to the axis A of the gas turbine engine 20. In another example, the step 86 extends in a non-perpendicular direction such that the step forms an undercut. The step 86 extends for a radial thickness D3.

In one example, the sum of R1 and R2 equals less than or equal to 50% of the thickness of region D3. In another example, the sum of R1 and R2 equals less than or equal to 25% of the thickness of region D3.

The thermally insulating topcoat 84 includes a leading edge region 92 and a trailing edge region 94 having a thickness D4 and an axially central region 96 having a thickness D5. The central region 96 extends from axially upstream of the turbine blade 60 to axially downstream of the turbine blade 60. The leading edge region 92 and the trailing edge region 94 are separated from the central region 96 by faults 98 extending radially through the thickness of the thermally insulating topcoat 84.

The faults 98 extend from the steps 86 formed in the bond coat 82 and reduce internal stresses within the thermally insulating topcoat 84 that may occur from sintering of the thermal material at relatively high surface temperatures within the turbine section 28 during use of the gas turbine engine 20. Although the central region 96 is separated from the trailing edge 74 by the trailing edge region 94, the central region 96 could extend to the trailing edge 74.

In one example, the thickness of region D1 is approximately 0.019 inches (0.483 mm), the thickness of region D4 is approximately 0.012 inches (0.305 mm), the thickness of region D2 is approximately 0.007 inches (0.178 mm), the thickness of region D3 is approximately 0.012 inches (0.305 mm) and the thickness of region D5 is approximately 0.025 inches (0.635 mm). In one example, at least one of the radius R1 and the radius R2 are approximately 0.003 inches (0.076 mm). In another example, at least one of the radius R1 and the radius R2 are less than 0.004 inches (0.102 mm). In yet another example, at least one of the radius R1 and the radius R2 are less than 0.005 inches (0.127 mm).

Depending on the composition of the thermally insulating topcoat 84, surfaces temperatures of about 2500° F. (1370° C.) and higher may cause sintering. The sintering may result in partial melting, densification, and diffusional shrinkage of the thermally insulating topcoat 84. The faults 98 provide pre-existing locations for releasing energy associated with the internal stresses (e.g., reducing shear and radial stresses). That is, the energy associated with the internal stresses may be dissipated in the faults 98 such that there is less energy available for causing delamination cracking between the thermally insulating topcoat 84 and the bond coat 82.

The faults 98 may vary depending upon the process used to deposit the thermally insulating topcoat 84. In one example, the faults 98 may be gaps between adjacent regions. In another example, the faults 98 may be considered to be microstructural discontinuities between the adjacent regions 92, 94, and 96. The faults 98 may also be planes of weakness in the thermally insulating topcoat 84 such that the regions 92, 94, and 96 can thermally expand and contract without cracking the thermally insulating topcoat 84.

The material selected for the substrate 80, the bond coat 82, and the thermally insulating topcoat 84 are not necessarily limited to any kind. In one example, the substrate 80 is made of a nickel based alloy and the thermally insulating topcoat 84 is an abradable ceramic material suited for providing a desired heat resistance.

The faults 98 in the thermally insulating topcoat 84 on the seal member 64 may be formed during application of the thermally insulating topcoat 84. Once the bond coat 82 has been applied to the substrate 80, the bond coat 82 is machined or ground to form the step 86 with the radially outer fillet 90 and the radially inner edge 88 having the desired radius R2 and R1, respectively. Alternatively, the step 86 is formed in the substrate 80 and the bond coat 82 is only applied to the radially inward facing portions of the substrate 80 excluding the step 86 in order to facilitate formation of the fault 98 along the step 86. Therefore, the substrate 80 would include a first portion have a first thickness and a section portion having a second thickness different from the first thickness

The thermally insulating topcoat 84 is applied to the bond coat 82 and/or substrate 80 with a thermal spray process. The thermal spray process allows the thermally insulating topcoat 84 to build up discontinuously such that there is no bridging between the leading edge region 92, the central region 96, and the trailing edge region 94. Because of the discontinuity created by the step 86, the continued buildup of the thermally insulating topcoat 84 between the central region 96 and the leading and trailing regions 92 and 94 forms the faults 98. The radially inner side 78 of the seal member 64 may be machined to remove unevenness introduced by the varying thickness associated with thermal spraying the step 86.

FIGS. 4-6 illustrate another example seal member 164. The seal member 164 is similar to the seal member 64 except where described below or shown in the Figures. The seal member 164 includes the substrate 80 covered by a bond coat 182. The bond coat includes a leading edge portion 182a axially upstream of a step 186 and a trailing edge portion 182b axially downstream of the step 186. The leading edge portion 182a and the trailing edge portion 182b include geometric features 185 formed in the bond coat 182. In this example, the geometric features 185 are cylindrical. However, other shapes such as elliptical or rectangular rods could be formed in the bond coat 182. Alternatively, the geometric features 185 could be formed in the substrate 80 with the radially inner surface of the substrate 80 being covered with the bond coat 182.

The thermally insulating topcoat 84 can be applied as discussed above. However, when the thermally insulating topcoat 84 is applied over the geometric features 185, faults 199 will form in the thermally insulating topcoat 184 in addition to a fault 198 formed radially inward from the step 186. The faults 198 and 199 form in a similar fashion as the faults 98 described above.

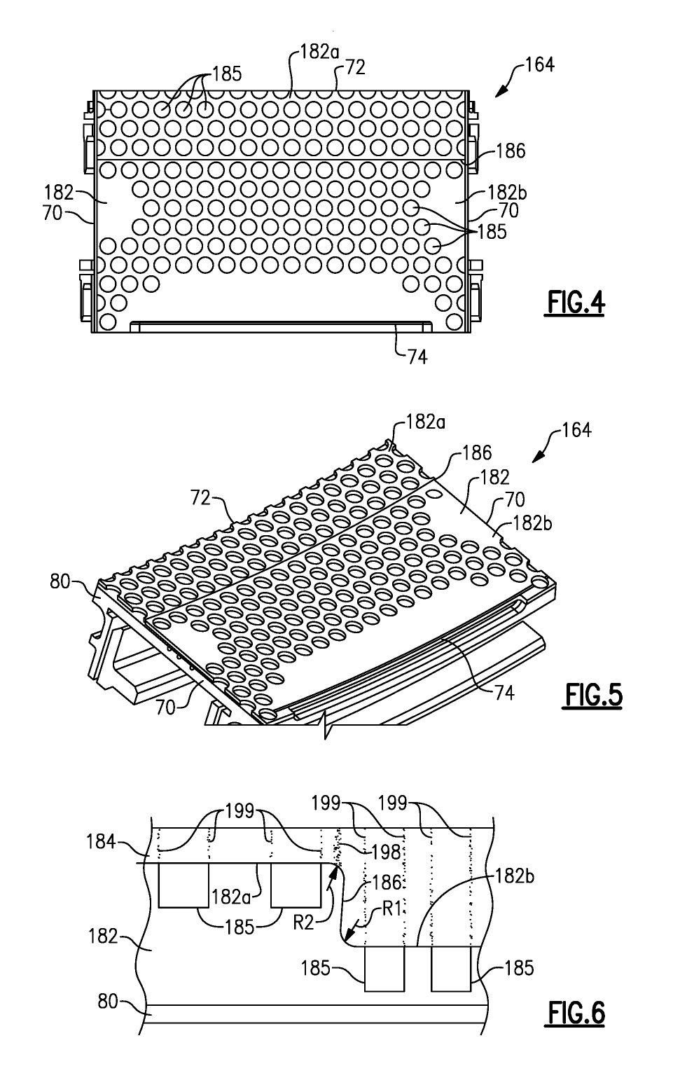

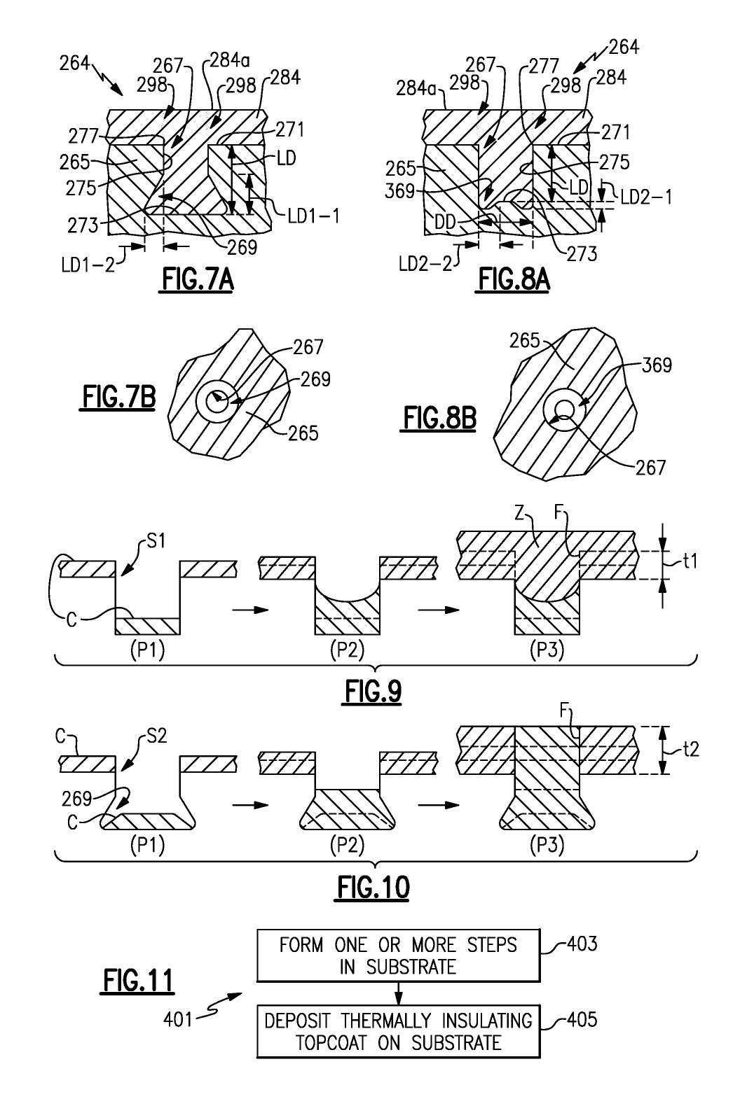

FIG. 7A illustrates a cross-section of a representative portion of a seal member 264. In this example, the seal member 264 includes a substrate 265 that has one or more steps 267. Although only one representative step 267 is shown, the substrate 265 may include a plurality of such steps 267. For example, the steps 267 may be provided in a pattern, similar to the pattern shown in FIGS. 4 and 5. The substrate 265 can be metallic, ceramic, or a combination thereof, and may be, or may include, a bond coat.

The step 267 includes undercut 269, which as discussed below, facilitates the formation of the faults 298 in the overlying thermally insulating topcoat 284. As used herein, the term “undercut” refers to a recessed region. Although an “undercut” may be formed by a cutting action, the term does not necessarily imply formation by cutting action.

FIG. 7B shows a radially outward view of the portion of the seal member 264 but without the thermally insulating topcoat 284 (i.e. a view from the engine central longitudinal axis A). As shown, the step 267 in this example is annular. Although shown as a circular annulus, the step 267 may alternatively be elliptical, rectangular, toroidal, or other geometric shape. Likewise, the undercut 269 is also annular.

Relative to an outer surface 284a of the thermally insulating topcoat 284, the step 267 includes (FIG. 7A) a proximal surface 271, a distal surface 273, and a sidewall 275 that joins the proximal surface 271 and the distal surface 273. The proximal surface 271 and the distal surface 273 face radially inwardly, toward the core flow path and engine central axis A. The sidewall 275 and the proximal surface 271 meet at a 90° corner 277. In this example, the undercut 269 is in the sidewall 275. The undercut 269 is thus a recessed region of the sidewall 275.

FIG. 8A shows a modified version of the seal member 264. In this example, rather than the undercut 269 in the sidewall 275, there is an undercut 369 in the distal surface 273. The undercut 369 is thus a recessed region of the distal surface 273.

The undercuts 269/369 facilitate formation of the faults 298 that extend from the step 267 by avoiding or reducing the potential for bridging of the thermally insulating topcoat 284 during spray deposition (e.g., thermal spray) of the topcoat 284. To illustrate, FIGS. 9 and 10 each show three progressions through a spray deposition process. In FIG. 9 the step, S1, does not have an undercut. In the first progression at P1 on the left-hand side, the coating, C, begins to build up on the surfaces around the step S1 and at the bottom of the step. In the middle progression at P2, due to deflection of the sprayed coating material, the coating builds-up more rapidly along the sidewall of the step S1 (i.e., the coating builds in a non-planar manner). In the last progression at P3 on the right-hand side, the coating build-up along the sidewall of the step S1 has caused bridging of the coating across the step in region Z. The faults, F, thus do not extend into the region Z. The bridging limits formation of the faults F and, in turn, limits the thickness, t1, of the coating that can be produced with faults F. For ceramic materials, such as stabilized zirconia, that are used for thermally insulating topcoats, this thickness is less than the depth of the step.

In FIG. 10 the step, S2, has an undercut (i.e. undercut 269). In the first progression at P1 on the left-hand side, the coating, C, begins to build up on the surfaces around the step S2 and at the bottom of the step S2. In the middle progression at P3, the undercut allows deflected coating material to spread laterally. Thus, the coating does not build-up along the sidewall (i.e., builds in a planar manner). In the last progression at P3 on the right-hand side, due to avoidance of build-up along the sidewall there is no bridging, and the faults, F, thus extend to the surface or very near surface of the coating. The elimination or reduction in the potential for bridging permits a greater thickness, t2, of the coating that can be produced with faults. For ceramic materials, such as stabilized zirconia, that are used for thermally insulating topcoats, this greater thickness may be equal to or greater than the depth of the step.

Similar to the undercut 269, the undercut 369 eliminates or reduces the potential for bridging. However, rather than permitting the coating to deflect and spread laterally during spray deposition, the undercut 369 permits the coating to spread in the depth direction such that the coating does not build-up along the sidewall.

The 90° corner 277 may also facilitate formation of the faults 298. For instance a highly rounded edge would provide less of a distinct change in depth at the step and thus contribute to bridging across the step. However, the 90° corner 277 provides a distinct change in depth and the step 267 and thus facilitates the formation of the thermally insulating topcoat 284 in a planar manner, which in turn facilitates formation of the faults 298 through the full thickness of the topcoat 284.

The undercuts 269/369 may be configured in size to more effectively facilitate the elimination or reduction in the potential for coating build-up and bridging. For example, referring again to FIG. 7A, the sidewall 275 defines a linear (radial) distance, LD, between the proximal surface 271 and the distal surface 273. For example, the linear distance is along a direction that is perpendicular to the engine central longitudinal axis A. In one example, the undercut 269 comprises at least 10%, represented at linear height LD1-1, of the linear distance LD and may be up to 100% of the linear distance LD. In a further example, LD1-1 is 10% to 100% of the linear distance or 25% to 50% of the linear distance. The undercut 269 also defines a lateral undercut distance (perpendicular width to LD1-1), represented at LD1-2, which is at least 5% of the linear distance LD and may be up to 100% of the linear distance LD. In a further example, LD1-2 is 10% to 100% of the linear distance or 10% to 25% of the linear distance. In the context of the function of the undercut 269, LD1-1 and LD1-2 thus represent a minimum relative size of the undercut 269 to more effectively allow spread of the coating material during coating deposition, relative to a given depth of the step 267. For example, the sum of the percentages for LD1-1 and LD1-2 may be at least 20%. In a further example, the sum of the percentages for LD1-1 and LD1-2 is at least 20%, LD1-1 is at least 15% and LD1-2 is at least 5%. In further examples, the sum of the percentages for LD1-1 and LD1-2 is at least 75%, at least 100%, or at least 150%, which each provide more space for spread of the coating material during coating deposition. In one further example, the sum of the percentages for LD1-1 and LD1-2 is at least 150% and the angle of the undercut 269 is approximately 45°.

Similarly, the size of the undercut 369 (FIG. 8A) may comprise less than about 50%, represented at LD2-1, of the linear distance LD and a lateral undercut distance, represented at LD2-2, may comprise less than about 50% of a diametric distance DD of the of the step 267. In a further example, LD2-1 is the smaller of, or is less than the smaller of, about 25% of the linear distance LD or about 25% of the diametric distance DD. In a further example, LD2-2 is about 25% of the diametric distance DD. In any of the above examples, the undercut 369 may also define a straight taper from a central region to the sidewall 275. In an additional example, the sum of the percentages for LD2-1 and LD2-2 may be at least 20% % and less than approximately 100% with respect to the linear distance LD, the diametric distance DD, or combinations.

FIG. 11 illustrates an example method 401 of fabricating a gas turbine engine article, such as the seal members disclosed herein. In this example, the method 401 includes a forming process 403 and a deposition process 405. The forming process step includes forming one or more steps with an undercut in a substrate, such as forming the step 267 and undercut 269 or 369 in substrate 265. The deposition process 405 includes depositing a thermally insulating topcoat on the substrate, such as the thermally insulating topcoat 284. As discussed herein, one or more faults form in the topcoat during deposition and extend from the step in the substrate.

The substrate and one or more steps with an undercut can be formed using one or more of several different processing techniques. For example, one cost effective processing technique includes forming the substrate and the one or more steps using additive manufacturing. Direct metal laser sintering and electron-beam melting are non-limiting examples of additive manufacturing techniques. In additive manufacturing a powdered material is fed to a machine, which may provide a vacuum, for example. The machine deposits multiple layers of the powdered material onto one another. At each iteration of layer deposition, the layer is selectively consolidated with reference to Computer-Aided Design data of the component being formed. Other layers or portions of layers corresponding to negative features, such as cavities or openings, are not joined and thus remain as a powdered material. The unjoined powder material may later be removed using blown air, for example. The additive manufacturing technique may be used to make the step 267 and undercut 269 or 369.

Another processing technique includes forming an undercut using chemical milling. In this example, a substrate is provided that initially has a step without an undercut. A chemical, such as an acid etchant, is used to form the undercut. Other areas of the substrate may be masked off. Such a chemical milling technique may be used to make the undercut 269 or 369.

Another processing technique includes forming a step and an undercut using laser ablation milling. In this example, a substrate is provided that initially has a step without an undercut. A high frequency pulsed laser beam, is used to form the undercut. Such a chemical milling technique may be used to make the undercut 269 or 369.

Another processing technique includes forming a step and an undercut using mechanical milling. In this example, a substrate is provided that initially has no step. A tool, such as a drill bit or other cutting tool, is used to form the step and the undercut. The tool has a concave tip or other such configuration that forms the undercut. Such a mechanical milling technique may be used to make the step 267 and undercut 369.

Any of the above processing techniques can additionally include formation of the 90° corner 277. For example, the 90° corner 277 may be formed during formation of the step 267 in an additive manufacturing or milling technique. Additionally or alternatively, the 90° corner 277 may be formed by grinding down the surface of the substrate 265. Thus, if the edge between the proximal surface 271 and the sidewall 275 is initially rounded, the rounded portion can be removed by grinding to produce the 90° corner 277.

Although the different non-limiting embodiments are illustrated as having specific components, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A gas turbine engine article comprising:
a substrate including at least one step, the at least one step having an undercut; and
a thermally insulating topcoat disposed on the substrate, the thermally insulating topcoat including at least one fault extending from the at least one step.

2. The article as recited in claim 1, wherein the at least one step includes, relative to an outer surface of the thermally insulating topcoat, a proximal surface, a distal surface, and a sidewall that joins the proximal surface and the distal surface, and the undercut is in the sidewall.

3. The article as recited in claim 2, wherein the sidewall defines a linear distance between the proximal surface and the distal surface, and the undercut defines a linear height of at least about 10% of the linear distance.

4. The article as recited in claim 2, wherein the sidewall defines a linear distance between the proximal surface and the distal surface, and the undercut defines a lateral undercut distance that is at least about 5% of the linear distance.

5. The article as recited in claim 1, wherein the at least one step includes, relative to an outer surface of the thermally insulating topcoat, a proximal surface, a distal surface, and a sidewall that joins the proximal surface and the distal surface, and the undercut is in the distal surface.

6. The article as recited in claim 5, wherein the sidewall defines a linear distance between the proximal surface and the distal surface, and the undercut has a linear height of less than about 50% of the linear distance.

7. The article as recited in claim 5, wherein the sidewall defines a diametric distance, and the undercut defines a lateral undercut distance that is less than about 50% of the diametric distance.

8. The article as recited in claim 1, wherein the at least one step includes, relative to an outer surface of the thermally insulating topcoat, a proximal surface, a distal surface, and a sidewall that joins the proximal surface and the distal surface, and the sidewall and the proximal surface meet at a 90° corner.

9. The article as recited in claim 1, wherein the at least one step is annular.

10. The article as recited in claim 1, wherein the at least one step includes a plurality of steps in a pattern.

11. The article as recited in claim 1, wherein the at least one fault is a microstructural discontinuity in the topcoat.

12. The article as recited in claim 1, wherein the fault extends to a surface of the thermally insulating topcoat.

13. A gas turbine engine comprising:
a plurality of rotatable blades; and
a seal arranged radially outwards of the plurality of rotatable blades, the seal including,
a substrate including at least one step, the at least one step having an undercut; and
a thermally insulating topcoat disposed on the substrate, the thermally insulating topcoat including at least one fault extending from the at least one step.

14. The engine as recited in claim 13, wherein the at least one step includes, relative to an outer surface of the thermally insulating topcoat, a proximal surface, a distal surface, and a sidewall that joins the proximal surface and the distal surface, and the undercut is in the sidewall.

15. The engine as recited in claim 13, wherein the at least one step includes, relative to an outer surface of the thermally insulating topcoat, a proximal surface, a distal surface, and a sidewall that joins the proximal surface and the distal surface, and the undercut is in the distal surface.

16. The engine as recited in claim 13, wherein the at least one step is annular.

17. A method for fabricating a gas turbine engine article, the method comprising:
forming at least one step in a substrate, the at least one step having an undercut; and
depositing a thermally insulating topcoat on the substrate, the thermally insulating topcoat forming at least one fault during the depositing that extends from the at least one step.

18. The method as recited in claim 17, wherein the forming includes forming the at least one step and undercut using at least one of additive manufacturing, chemical milling, or mechanical milling.

19. The method as recited in claim 17, wherein the at least one step includes, relative to an outer surface of the thermally insulating topcoat, a proximal surface, a distal surface, and a sidewall that joins the proximal surface and the distal surface, and the undercut is formed in the sidewall.

20. The method as recited in claim 17, wherein the at least one step includes, relative to an outer surface of the thermally insulating topcoat, a proximal surface, a distal surface, and a sidewall that joins the proximal surface and the distal surface, and the undercut is formed in the distal surface.
